(19) United States
(12) Patent Application Publication
(10) Pub. No.: US 2015/0033967 A1
(43) Pub. Date: Feb. 5, 2015

(54) INTAGLIO PRINTING PLATE, METHOD OF MANUFACTURING THE SAME AND USE THEREOF

(71) Applicant: Jacques Perrier, Commugny (CH)

(72) Inventor: Jacques Perrier, Commugny (CH)

(73) Assignee: KBA-NOTASYS SA, Lausanne 22 (CH)

(21) Appl. No.: 14/112,353

(22) PCT Filed: Apr. 11, 2012
(86) PCT No.: PCT/IB2012/051754

§ 371 Date: Dec. 12, 2013

(30) Foreign Application Priority Data
Apr. 18, 2011 (EP) 11162903.6

(51) Int. Cl. B41N 1/12; B41N 3/03; B41M 3/14

(52) U.S. Cl. CPC B41N 1/12; B41M 3/14; B41N 3/03
USPC 101/170; 101/395; 427/555

(57) ABSTRACT

There is described an intaglio printing plate (1; 1*) for the production of banknotes and like printed securities, which intaglio printing plate comprises an engraved polymer layer (10) and wherein a surface of the engraved polymer layer is covered by one or more coatings (100; 200, 300) including an outer coating (100; 300) made of a wear-resistant material. The outer coating (100; 300) is advantageously formed by physical vapour deposition (PVD) of the wear-resistant material. Also described is a method of manufacturing the intaglio printing plate (1; 1*).

### TECHNICAL FIELD

The present invention generally relates to an intaglio printing plate for the production of banknotes and like printed securities and a method of manufacturing such an intaglio printing plate, which intaglio printing plate can be used in an intaglio printing press for the production of banknotes and like printed securities.

### BACKGROUND OF THE INVENTION

Intaglio printing plates for the production of banknotes and like printed securities and methods of manufacturing the same are already known in the art.

International Publication No. WO 03/103962 A1, which is incorporated herein by reference in its entirety, discloses such an intaglio printing plate and a method of manufacturing the same. According to an advantageous embodiment of International Publication No. WO 03/103962 A1, a polymer plate comprising a laser-engravable polymer layer, preferably a polyimide material containing dispersed carbon black material, is engraved by laser engraving to produce a so-called precursor plate of an intaglio printing plate. This precursor plate is then typically silvered and used to produce a so-called (nickel) alto plate by processing the engraved precursor plate in galvanic baths in order to deposit and grow a layer of metallic material, typically nickel, on the surface of the precursor plate. The alto plate is then separated from the engraved precursor plate (which precursor plate is destroyed in the process). The thus-obtained alto plate is basically the mirror image in relief of the engraved precursor plate and is used to produce intaglio printing plates which end up on the printing press. Such intaglio printing plates are similarly produced by processing the alto plate in galvanic baths in order to deposit and grow a layer of metallic material, again typically nickel, on the surface of the alto plate, the alto plate being separated from the thus-obtained intaglio printing plate and being usable again to produce further intaglio printing plates. Further processing steps are required before the intaglio printing plates can be used on an intaglio printing press, which processing steps typically include:
polishing of the surface of the precursor plate, of the alto plate and/or of the intaglio printing plate,
deposition of a layer of wear-resistant material, typically chromium (Cr), on the surface of the intaglio printing plate (which deposition is typically carried out by processing the intaglio printing plate in a further galvanic bath, e.g. a chromium bath),
rectification of the rear side of the intaglio printing plate, and
finalisation of the intaglio printing plate for mounting on an intaglio printing press.

Direct use of the engraved polymer precursor plate discussed above in an intaglio printing press is possible for proofing purposes and very limited production runs. Indeed the friction between the engraved polymer precursor plate and the wiping roller or cylinder that is typically used in intaglio printing presses (see e.g. International Publication No. WO 2007/116353 A1 for a description of an example of a wiping roller assembly for an intaglio printing press) causes a quick deterioration of the surface of the wiping roller or cylinder and degrades the quality of the engraved polymer precursor plate, rapidly leading to very poor printing quality.

In summary, manufacturing of intaglio printing plates on the basis of an engraved polymer precursor plate requires processing in several galvanic baths, which is time consuming, costly, and may give rise to potential issues from an environmental point of view, taking into account the fact that galvanic baths make use of environmentally unfriendly chemical agents and/or produce environmentally unfriendly chemical derivatives that shall be treated with great care.

International Publication No. WO 2009/138901 A1, which is incorporated herein by reference in its entirety, discloses a method and system for manufacturing intaglio printing plates for the production of security papers. According to WO 2009/138901 A1, a laser-engravable metallic printing medium is directly engraved by means of a laser beam to produce the intaglio printing plate per se. Thanks to such a method, most of the galvanic processing discussed above may be eliminated.

The direct laser engraving of metallic printing plate mediums however still has a disadvantage in that several engraving passes are required in order to fully engrave the intaglio printing plate up to the desired depths, which is time-consuming. Furthermore, melted residues from the engraving process may negatively affect engraving quality and thus printing quality, which necessitates careful intermediate cleaning of the surface of the plate to remove unwanted residues of the plate material as discussed in International Publication No. WO 2009/138901 A1. All in all this typically leads to lowering the engraving resolution to achieve reasonably acceptable engraving times.

There is therefore a need for an improved solution for the production of intaglio printing plates.

### SUMMARY OF THE INVENTION

A general aim of the invention is therefore to improve the known intaglio printing plates and methods of manufacturing the same.

In particular, an aim of the present invention is to provide a solution that is environmentally friendly to implement, while being more optimal from the point of view of manufacturing time and costs.

These aims are achieved thanks to the solution defined in the claims.

More precisely, there is provided an intaglio printing plate for the production of banknotes and like printed securities, which intaglio printing plate comprises an engraved polymer layer and wherein the engraved polymer layer is covered by one or more coatings including an outer coating made of a wear-resistant material. According to the invention, the outer coating is advantageously formed by physical vapour deposition (PVD) of the wear-resistant material.

The outer coating provides for a substantial hardening of the surface of the engraved polymer layer, making it possible to use the polymer based intaglio printing plate directly in an intaglio printing press for long production runs.

Preferably, the polymer layer is a laser-engraved polymer layer, which may advantageously contain laser-absorbing particles or additives, such as carbon black material, dispersed in the polymer layer. Such polymer layer can in particular be a polyimide material, such as Kapton material. Polyimide material like the Kapton material is very much adapted to the PVD process as Kapton material can withstand the high processing temperatures that are typically involved when applying coating material by PVD coating techniques.

According to the invention, the outer coating is formed by physical vapour deposition (or PVD) of the wear-resistant material. Tests carried out by the Applicant have demonstrated that the outer coating formed by physical vapour deposition provides for a particularly resistant coating of the polymer-based intaglio printing plate.

According to an embodiment of the invention, at least an intermediate coating is interposed between the surface of the engraved polymer layer and the outer coating. This intermediate coating is preferably formed by physical vapour deposition (or PVD) of a coating material.

The wear-resistant material of the outer coating can be suitably selected from the group of coating materials comprising chromium (Cr), chromium nitride (CrN), chromium carbon nitride (CrCN), titanium (Ti), titanium nitride (TiN), titanium carbon nitride (TiCN), titanium aluminium nitride (TiAlN) or aluminium titanium nitride (AlTiN), and titanium aluminium carbon nitride (TiAlCN). The key function of the wear-resistant material is to ensure proper and adequate resistance to wear and to allow the intaglio printing plate to be used for long production runs.

The coating material of the intermediate coating can be suitably selected from the group of coating materials comprising nickel (Ni), chromium (Cr), titanium (Ti) or derivatives thereof.

In the context of the present invention, it is contemplated to make use of a polymer layer having preferably a thickness in the range of 100 to 200 microns. Such polymer layer can be formed on a metallic base plate which provides adequate support for the polymer layer.

The thickness of the outer coating of wear-resistant material is advantageously of 5 microns or less, preferably of 1 micron or less. Even though greater coating thicknesses are possible, a coating thickness of the order of one or a few microns is already sufficient to achieve increased resistance of the polymer-based intaglio printing plate. Furthermore, a relatively thin coating is expected to show better behaviour during printing as the thin coating will potentially allow for some elastic deformation under stress without leading to breakage of the coating.

Also claimed is a method of manufacturing the above intaglio printing plate, comprising the steps of:
providing a non-engraved plate medium having an engravable polymer layer ;
engraving the polymer layer ; and
covering the surface of the engraved polymer layer with one or more coatings including an outer coating made of a wear-resistant material, wherein the outer coating is formed by physical vapour deposition (PVD) of the wear-resistant material.

The engravable polymer layer is preferably a laser-engravable polymer layer as discussed above, engraving of the polymer layer being carried out by laser engraving.

Also claimed is the use of the above intaglio printing plate in an intaglio printing press for the production of banknotes and like printed securities.

Further advantageous embodiments of the invention form the subject-matter of the dependent claims and are discussed below.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIG. 1 is a schematic cross-section of an intaglio printing plate according to one embodiment of the invention; and

FIG. 2 is a schematic cross-section of an intaglio printing plate according to a second embodiment of the invention.

### DETAILED DESCRIPTION OF EMBODIMENTS OF THE INVENTION

The invention will be described hereinafter in the context of an intaglio printing plate manufactured by laser engraving of a laser-engravable polymer layer. While laser engraving is a preferred way of engraving the polymer layer according to the invention, the polymer layer could alternatively be engraved mechanically, e.g. by means of a rotating chisel of like engraving tools.

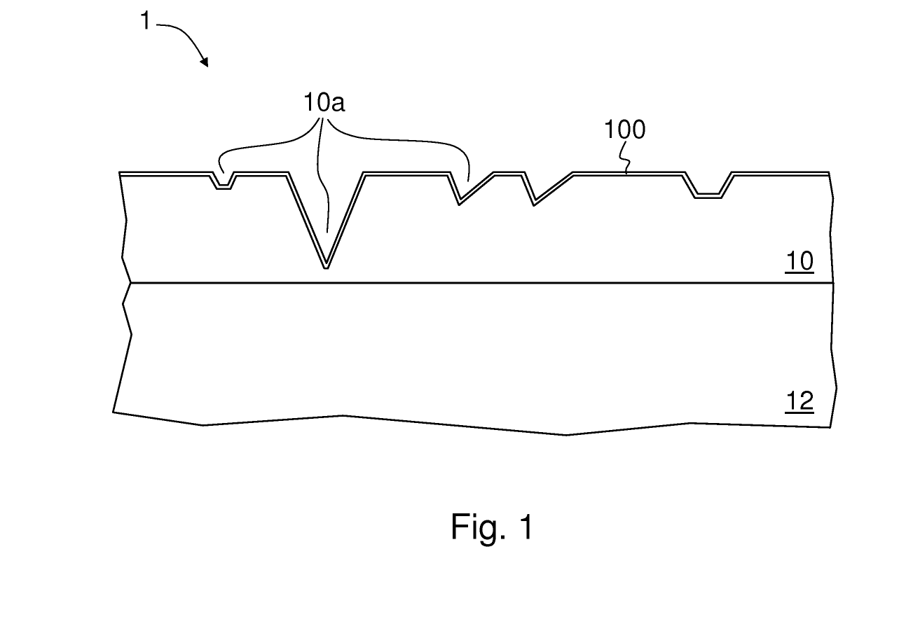

FIG. 1 shows a schematic cross-section of an intaglio printing plate according to one embodiment of the invention. It is to be appreciated that the dimensions, especially the thickness of the various layers and size of the engravings are not necessarily drawn to scale.

More precisely, FIG. 1 shows an intaglio printing plate, designated generally by reference numeral 1, comprising an engraved polymer layer 10 with engravings 10a, which polymer layer 10 is supported on a base plate 12. Such base plate 12 can for instance be a metallic base plate.

The engraved polymer layer 10 according to this embodiment is a laser-engraved polymer layer, i.e. the polymer layer 10 is made of a material suitable for carrying out engraving of the polymer layer 10 by means of a laser beam. Advantageously, the polymer layer 10 contains laser-absorbing particles or additives, such as carbon black material, which are dispersed in the polymer layer 10. Such particles or additives ensure optimal absorption of the laser energy and sublimation of the processed polymer material, and thereby optimal engraving quality. A particularly convenient polymer material to be used in the context of this embodiment is a polyimide material, such as Kapton material sold by company Du Pont de Nemours.

The laser-engravable polymer layer 10 is preferably engraved according to the method disclosed in International Publication No. WO 03/103962 A1 which is discussed in the preamble hereof and is incorporated herein by reference. Other engraving methods may however be envisaged.

The polymer layer 10 preferably exhibits a thickness in the range of 100 to 200 microns, which thickness is suitable for the engraving of most types of intaglio patterns.

FIG. 1 further shows that a surface of the engraved polymer layer 10 is covered by a coating 100 made of a wear-resistant material, which forms the outer coating of the intaglio printing plate 1. According to this embodiment of the invention, the outer coating 100 was formed by physical vapour deposition (or PVD) of the wear-resistant material directly on the surface of the engraved polymer layer 10.

The outer coating 100 provides for a substantial hardening of the surface of the engraved polymer layer 10, making it possible to use the polymer based intaglio printing plate directly in an intaglio printing press for long production runs. Furthermore, tests carried out by the Applicant have shown that an outer coating made e.g. of chromium (Cr) exhibits very high adhesion to the underlying polymer layer 10 made of e.g. Kapton, without this necessitating additional coating layers.

This is a substantial advantage as compared to the use of engraved polymer precursor plates as disclosed in International Publication No. WO 03/103962 A1 where such polymer precursor plates are only intended to be used as matrix for the formation of an alto plate (and the resulting intaglio printing plates) by conventional galvanic bath processing. Indeed, thanks to the invention, the nickel galvanic baths as typically used in the art to produce the alto plates and the intaglio printing plates may be completely eliminated if necessary.

The formation by physical vapour deposition (PVD) of the outer coating 100 may further allow for the complete elimination of all galvanic baths in the context of the production of intaglio printing plates, which has a highly positive impact from an environmental point of view.

Furthermore, keeping the polymer layer 10 as the engravable medium for the formation of the desired engravings of the intaglio printing plate is highly advantageous in that an entire plate can be engraved in a single pass, with high engraving accuracy, high resolution, and within a relatively short period of time.

A suitable coating material for the outer coating 100 is chromium (Cr). It is however also possible to use other coating materials besides chromium (Cr), such as chromium nitride (CrN), chromium carbon nitride (CrCN), titanium (Ti), titanium nitride (TiN), titanium carbon nitride (TiCN), titanium aluminium nitride (TiAlN) or aluminium titanium nitride (AlTiN), and titanium aluminium carbon nitride (TiAlCN).

Tests carried out by the Applicant have demonstrated that an outer coating 100 formed by physical vapour deposition (PVD) of e.g. chromium (Cr) on the surface of an engraved polymer layer made of e.g. Kapton material is properly adhering thereto and provides for a particularly resistant coating of the surface of the engraved polymer layer 10.

A thickness of the outer coating 100 of wear-resistant material can conveniently be in the range of 5 microns or less. Tests carried out by the Applicant have in particular demonstrated that a thickness of the order of 1 micron (or less) was already sufficient to provide for a substantially increased resistance of the polymer-based intaglio printing plate 1.

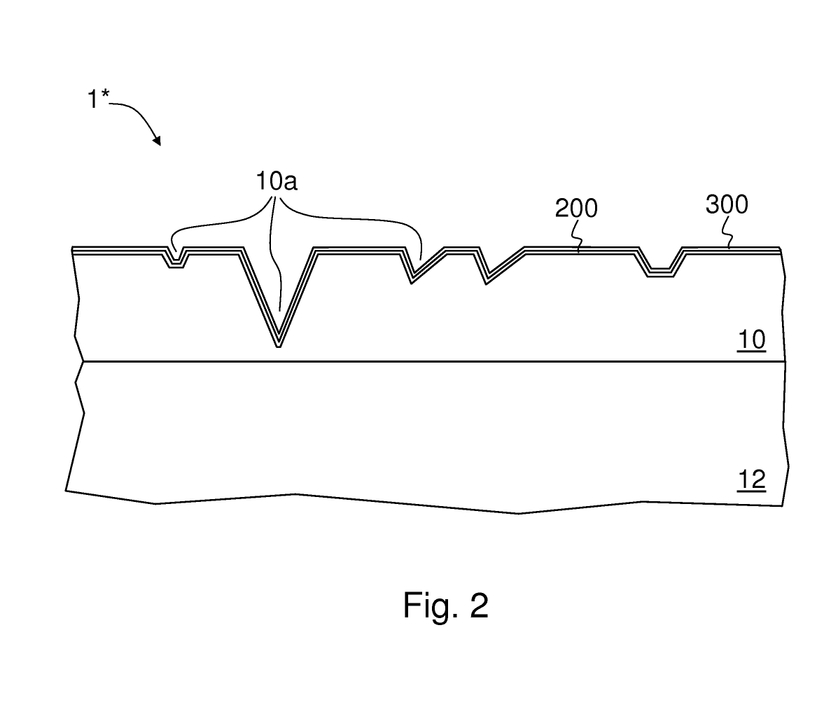

FIG. 2 shows a schematic cross-section of an intaglio printing plate, designated by reference numeral 1*, according to another embodiment of the invention. It is again to be appreciated that the thickness of the various layers and size of the engravings are not necessarily drawn to scale.

The intaglio printing plate 1* of FIG. 2 differs from the intaglio printing plate 1 of FIG. 1 in that an intermediate coating 200 is interposed between the surface of the engraved polymer layer 10 and the outer coating, designated in this other embodiment by reference numeral 300.

According to this other embodiment of the invention, the intermediate coating 200 was also formed by physical vapour deposition (or PVD) of coating material on the surface of the engraved polymer layer.

A suitable coating material for the intermediate coating 200 is preferably selected from the group of coating materials comprising nickel (Ni), chromium (Cr), titanium (Ti) or derivatives thereof. A function of the intermediate coating 200 is essentially to act as adhesion promoter between the surface of the engraved polymer layer 10 and the outer coating 300. Resistance to wear is not so much of an issue as far as the intermediate coating 200 is concerned as this intermediate coating 200 is not exposed on the surface of the intaglio printing plate 1*.

Suitable combinations of materials for the intermediate coating 200 and the outer coating 300 of the embodiment of FIG. 2 may include an intermediate coating 200 of nickel (Ni), chromium (Cr) or titanium (Ti) covered by an outer coating 300 made of a coating material selected from the group of coating materials comprising chromium (Cr), chromium nitride (CrN), chromium carbon nitride (CrCN), titanium (Ti), titanium nitride (TiN), titanium carbon nitride (TiCN), titanium aluminium nitride (TiAlN) or aluminium titanium nitride (AlTiN), and titanium aluminium carbon nitride (TiAlCN), as discussed above. Such coating materials have demonstrated their value to form particularly resistant coatings for the polymer-based intaglio printing plate, leading to even longer life cycles.

In the context of FIG. 2, the intermediate coating 200 may advantageously be a titanium (Ti) coating while the outer coating 300 may be a titanium nitride (TiN) coating, or a derivative thereof such as titanium carbon nitride (TiCN), titanium aluminium nitride (TiAlN), aluminium titanium nitride (AlTiN) or titanium aluminium carbon nitride (TiAlCN), both coatings 200, 300 being suitably formed by physical vapour deposition (PVD).

It will be appreciated from the above that a method of manufacturing the above-discussed intaglio printing plate(s) for the production of banknotes and like printed securities, comprises the steps of:
providing a non-engraved plate medium having an engravable polymer layer 10 (preferably a laser-engravable polymer layer as discussed above);
engraving the polymer layer 10 (preferably by laser engraving); and
covering the surface of the engraved polymer layer 10 with one or more coatings 100, 200, 300 including an outer coating 100, 300 made of a wear-resistant coating material, which outer coating 100, 300 is formed by physical vapour deposition (PVD) of the wear-resistant material.

It is to be further appreciated that the intaglio printing plate discussed above can be used directly in an intaglio printing press for the production of banknotes and like printed securities.

One will appreciate and understand from the above discussion of embodiments of the invention that the deposition of one or more coatings, including an outer coating made of a wear-resistant material, directly on the engraved polymer plate allows to completely eliminate the nickel galvanic baths that are conventionally used in the art to produce alto plates and intaglio printing plates. It will further be appreciated that no rectification of the rear side of the intaglio printing plate is necessary anymore.

Furthermore, by opting for a physical vapour deposition (PVD) process to form the said one or more coatings, including the outer coating of wear-resistant material, one can potentially get rid of all galvanic baths, including the chromium galvanic baths that are typically used to form chromium layers on conventional nickel plates.

Various modifications and/or improvements may be made to the above-described embodiments of the invention without departing from the scope of the invention as defined by the annexed claims.

For instance, while laser engraving is a preferred methodology for engraving the polymer layer 10, the polymer layer 10 may alternatively be engraved by other means, such as mechanically by means of a rotating chisel or like mechanical engraving tool. It is however to be stressed that laser engraving of the polymer layer 10 is particularly advantageous in terms of flexibility, accuracy and rapidity.

Furthermore, while FIGS. 1 and 2 show embodiments wherein one, respectively two coatings are provided on the surface of the engraved polymer layer 10, more than two coatings may be contemplated without departing from the scope of the invention as defined by the annexed claims.

In this context, it is to be appreciated that the intermediate coating 200 of the embodiment of FIG. 2 may be a coating material whose function is essentially to maximise adhesion between the surface of the engraved polymer layer 10 and the outer coating 300 of wear-resistant material, the resistance to wear of the intermediate coating 200 being less of an issue in this case as such function is ensured by the outer coating 300.

In contrast, in the context of FIG. 1, the single coating 100 has to exhibit both good adhesion on the surface of the engraved polymer layer 10 and good resistance to wear as both functions are fulfilled by one and the same layer.

In addition, while a polyimide material, and Kapton material especially, has been described as a suitable polymer material, other polymer materials could be envisaged as long as they can both be adequately engraved (in particular by laser engraving) and withstand the typically high processing temperatures of the PVD coating process. Kapton material is however particularly advantageous in the context of the invention as it exhibits outstanding properties for both laser-engraving and PVD coating.

### LIST OF REFERENCES USED HEREIN

1 intaglio printing plate (first embodiment)

1* intaglio printing plate (second embodiment)

10 engraved polymer layer (e.g. laser-engravable polymer layer)

10a engravings in polymer layer 10

12 base plate of engraved polymer layer 10 (e.g. metallic base plate)

100 outer coating of wear-resistant material

200 intermediate coating

300 outer coating of wear-resistant material

1. Intaglio printing plate for the production of banknotes and like printed securities, wherein the intaglio printing plate comprises an engraved polymer layer and wherein a surface of the engraved polymer layer is covered by one or more coatings including an outer coating made of a wear-resistant material, wherein the outer coating is formed by physical vapour deposition (PVD) of the wear-resistant material.

2. Intaglio printing plate as defined in claim 1, wherein the polymer layer is a laser-engraved polymer layer.

3. Intaglio printing plate as defined in claim 2, wherein the polymer layer contains laser-absorbing particles or additives dispersed in the polymer layer.

4. Intaglio printing plate as defined in claim 3, wherein the laser-absorbing particles or additives are made of carbon black material.

5. Intaglio printing plate as defined in claim 3, wherein the polymer layer is made of a polyimide material.

6. Intaglio printing plate as defined in claim 5, wherein the polyimide material is Kapton material.

7. Intaglio printing plate as defined in claim 1, wherein at least one intermediate coating is interposed between the surface of the engraved polymer layer and the outer coating.

8. Intaglio printing plate as defined in claim 7, wherein the intermediate coating is formed by physical vapour deposition (PVD) of a coating material.

9. Intaglio printing plate as defined in claim 1, wherein the wear-resistant material of the outer coating is selected from the group of coating materials comprising chromium (Cr), chromium nitride (CrN), chromium carbon nitride (CrCN), titanium (Ti), titanium nitride (TiN), titanium carbon nitride (TiCN), titanium aluminium nitride (TiAlN) or aluminium titanium nitride (AlTiN), and titanium aluminium carbon nitride (TiAlCN).

10. Intaglio printing plate as defined in claim 7, wherein the coating material of the intermediate coating is selected from the group of coating materials comprising nickel (Ni), chromium (Cr), titanium (Ti) and derivatives thereof.

11. Intaglio printing plate as defined in claim 10, wherein the coating material of the intermediate coating is titanium (Ti) and the wear-resistant material of the outer coating is titanium nitride (TiN) or a derivative thereof.

12. Intaglio printing plate as defined in any claim 1, further comprising a metallic base plate supporting the polymer layer.

13. Intaglio printing plate as defined in claim 1, wherein the polymer layer has a thickness in the range of 100 to 200 microns and wherein the outer coating of wear-resistant material has a thickness of 5 microns or less.

14. Method of manufacturing an intaglio printing plate for the production of banknotes and like printed securities, comprising the steps of:
providing a non-engraved plate medium having an engravable polymer layer;
engraving the polymer layer; and
covering the surface of the engraved polymer layer with one or more coatings including an outer coating made of a wear-resistant material, wherein the outer coating is formed by physical vapour deposition (PVD) of the wear-resistant material.

15. Method as defined in claim 14, wherein the engravable polymer layer is a laser-engravable polymer layer and wherein engraving of the polymer layer is carried by laser engraving.

16. Method as defined in claim 15, wherein the polymer layer contains laser-absorbing particles or additives dispersed in the polymer layer.

17. Method as defined in claim 16, wherein the laser-absorbing particles or additives are made of carbon black material.

18. Method as defined in claim 16, wherein the polymer layer is made of a polyimide material.

19. Method as defined in claim 18, wherein the polyimide material is Kapton material.

20. Method as defined in claim 14, wherein the wear-resistant material of the outer coating is selected from the group of coating materials comprising chromium (Cr), chromium nitride (CrN), chromium carbon nitride (CrCN), titanium (Ti), titanium nitride (TiN), titanium carbon nitride (TiCN), titanium aluminium nitride (TiAlN) or aluminium titanium nitride (AlTiN), and titanium aluminium carbon nitride (TiAlCN).

21. Method as defined in claim 14, further comprising the step of providing at least one intermediate coating between the surface of the engraved polymer layer and the outer coating.

22. Method as defined in claim 21, wherein the intermediate coating is formed by physical vapour deposition (PVD) of a coating material.

23. Method as defined in claim 21, wherein the coating material of the intermediate coating is selected from the group of coating materials comprising nickel (Ni), chromium (Cr), titanium (Ti) and derivatives thereof.

24. Method as defined in claim 23, wherein the coating material of the intermediate coating is titanium (Ti) and the wear-resistant material of the outer coating is titanium nitride (TiN) or a derivative thereof.

25. Use of the intaglio printing plate as defined in claim 1 in an intaglio printing press for the production of banknotes and like printed securities.

26. Intaglio printing plate as defined in claim 11, wherein the wear-resistant material of the outer coating is titanium carbon nitride (TiCN), titanium aluminium nitride (TiAlN), aluminium titanium nitride (AlTiN), or titanium aluminium carbon nitride (TiAlCN).

27. Intaglio printing plate as defined in claim 13, wherein the outer coating of wear-resistant material has a thickness of 1 micron or less.

28. Method as defined in claim 24, wherein the wear-resistant material of the outer coating is titanium carbon nitride (TiCN), titanium aluminium nitride (TiAlN), aluminium titanium nitride (AlTiN), or titanium aluminium carbon nitride (TiAlCN).
